(19) United States
(12) Patent Application Publication
(10) Pub. No.: US 2014/0313342 A1
(43) Pub. Date: Oct. 23, 2014

(54) Photonic Bandgap Structures for Multispectral Imaging Devices

(71) Applicant: The Research Foundation for The State University of New York, Amherst, NY (US)

(72) Inventors: Qiaoqiang Gan, Tonawanda, NY (US); Alexander N. Cartwright, Williamsville, NY (US); Ke Liu, Amherst, NY (US); Huina Xu, Amherst, NY (US)

(73) Assignee: The Research Foundation for the State University of New York, Amherst, NY (US)

(21) Appl. No.: 14/356,253

(22) PCT Filed: Oct. 12, 2012
(86) PCT No.: PCT/US2012/060142

§ 371 Date: May 5, 2014

Related U.S. Application Data
(60) Provisional application No. 61/555,631, filed on Nov. 4, 2011.

(51) Int. Cl. G02B 1/00; H04N 5/33; H04N 5/232; G02B 5/18

(52) U.S. Cl. CPC G02B 1/005; G02B 5/1857; H04N 5/332; H04N 5/23238
USPC 348/162; 359/575; 264/1.37

(57) ABSTRACT

The invention discloses methods for making photonic bandgap structures and photonic bandgap structures made by those processes. In one embodiment, the photonic bandgap structure is flexible. In another photonic bandgap structure, the structure has a graded, periodic grating. One embodiment of a method according to the present invention comprises the steps of preparing a pre-polymer mixture, positioning that mixture between two slides, exposing the mixture to electromagnetic radiation, curing the mixture, and discarding at least one of the slides. In another embodiment of the method, the pre-polymer mixture is exposed to the electromagnetic radiation through a prism. In one embodiment of the method, the pre-polymer mixture is exposed to the electromagnetic radiation through a lens.

In one embodiment of the invention, the photonic bandgap structure is used as a filter in a multispectral imaging device comprising a imaging device, the filter, a processor, and an electronic image storage device.

### CROSS-REFERENCE TO RELATED APPLICATION

This application claims the benefit of priority to U.S. provisional patent application Ser. No. 61/555,631, filed on Nov. 4, 2011.

### FIELD OF THE INVENTION

This invention relates generally to the field of imaging and more particularly to multispectral imaging based on photopolymer reflection grating filters.

### BACKGROUND OF THE INVENTION

Multispectral imaging and hyperspectral imaging are widely used in remote sensing for military and defense applications, bio-imaging, as well as environmental, agricultural and climate monitoring. Hyperspectral imaging is part of a class of techniques commonly referred to as spectral imaging or spectral analysis. Hyperspectral imaging is related to multispectral imaging. The distinction between hyper- and multi-spectral is sometimes based on an arbitrary “number of bands” or on the type of measurement, depending on what is appropriate to the purpose.

Multispectral imaging deals with several images at discrete and somewhat narrow bands. Being “discrete and somewhat narrow” is what distinguishes multispectral in the visible from color photography. A multispectral sensor may have many bands covering the spectrum from the visible to the longwave infrared. Multispectral images do not produce the “spectrum” of an object.

Hyperspectral deals with imaging narrow spectral bands over a continuous spectral range, and produce the spectra of all pixels in the scene. So a sensor with only 20 bands can also be hyperspectral when it covers the range from 500 to 700 nm with 20 bands each 10 nm wide. As such, a sensor with 20 discrete bands covering the VIS, NIR, SWIR, MWIR, and LWIR bands would be considered multispectral. For the purposes of this application, the terms multispectral and hyperspectral are used interchangeably.

Although originally developed for mining and geology (the ability of hyperspectral imaging to identify various minerals makes it ideal for the mining and oil industries, where it can be used to look for ore and oil) hyperspectral imaging has now spread into fields as widespread as ecology and surveillance, as well as historical manuscript research such as the imaging of the Archimedes Palimpsest. Organizations such as NASA and the USGS have catalogues of various minerals and their spectral signatures, and have posted them online to make them readily available for researchers.

As illustrated above, multispectral sensing technology is used in a wide array of real-life applications. But, for these high-end and high-definition applications, high quality optical filters and cameras are required, leading to the expensive cost for the commercial products. To date, there are no low-cost, high-quality optical filter for products in the market that can perform simple multispectral and hyperspectral imaging.

Photonic bandgap structures have be utilized in the past as an optical filter, such as a graded bandpass filter. Previously, this was done by depositing multiple layers of variable thickness material in a wedge fashion that forms Fabry-Perot interference using radically variable filter fabrication and ion-assisted deposition. U.S. Pat. No. 5,872,655 and U.S. Pat. No. 6,700,690 describe depositing hundreds of layers, each step required to be performed with high degrees of precision. Needless to say, these optical filters are expensive and susceptible to physical forces that might alter the thickness of each layer (such as pressure, temperature, or mechanical stress).

Some photonic bandgap structures are formed from Holographic Polymer Dispersed Liquid Crystal (H-PDLC) materials. These H-PDLC materials belong to a phase separation material system where the liquid crystals (LC) can form droplets, of controllable sizes, that are phase separated from the polymer-rich regions during the photopolymerization process. The LCs provide electric-field sensitive optical elements that enable the fabrication of switchable transmissive and reflective diffraction optics. In recent years, variations of the standard H-PDLC system to fabricate highly reflective volume gratings and nanoporous polymer photonic crystals have emerged. For example, graded photonic or plasmonic structures have been prepared by expensive focus ion beam milling or electron beam lithography techniques. “Organic Solvent Vapor Detection Using Holographic Photopolymer Reflection Gratings” and “Nanoporous Polymeric Photonic Crystals by Emulsion Holography,” both by Hsaio et al. describe other variations. However, the prior art structures and the structures by Hsaio et al. cannot be made multispectral at the same viewing angle. As such, there remains a need for inexpensive, easily manufactured, durable, and precise photonic bandgap structures for multispectral imaging.

Therefore, the previous attempts and the prior art have been unsuccessful at developing an easily manufacturable, durable, and precise photonic bandgap capable of multispectral reflection at a single viewing angle.

### SUMMARY OF THE INVENTION

The present invention can be described as a method of making a photonic bandgap structure. In one embodiment, the steps of the method include preparing a photosensitive pre-polymer mixture, positioning the mixture between two slides, attaching a prism or lens to one of the slides, exposing the mixture to electromagnetic radiation, and curing the mixture. A photonic bandgap structure made by this method may also be flexible.

The step of preparing a photosensitive pre-polymer mixture involves mixing at least one monomer, at least one photoinitiator, at least one co-initiator, at least one liquid crystal, at least one reactive solvent mixture and at least one non-reactive solvent mixture. In one embodiment, the monomer is dipentaerythritol hydroxy penta acrylate, the photoinitiator is Rose Bengal, the coinitiator is N-Phenylglycine, the reactive solvent is N-vinylpyrrolidinone, the liquid crystal is TL213, and the non-reactive solvent is toluene.

The pre-polymer mixture is then positioned between a first slide and a second slide. The slides may be a rigid, translucent or transparent substance such as glass.

In one embodiment, a prism is attached to the first slide. In another embodiment, a lens is attached to the first slide. In embodiments where a lens is attached to the first slide, the final photonic bandgap structure will have a graded, periodic grating. The lens or prism may be attached to one of the slides using a refractive index matching material, such as a matching oil.

The pre-polymer mixture is exposed to electromagnetic radiation having a spatial interference pattern, the pattern created by passing one or more collimated laser beams through a prism or lens. The lens may be cylindrical, semi-cylindrical, convex-plano, positive meniscus, plano-concave, or biconcave. Photo-polymerization occurs in selected regions (i.e., regions of high electromagnetic intensity due to coherence) of the spatial interference pattern to make a photonic bandgap structure in the cured mixture. In one embodiment, the one or more collimated laser beams are focused in one dimension. In another embodiment, the one or more collimated laser beams are focused in two dimensions.

The mixture is cured and one or both of the slides are discarded. In one embodiment, a reflective film is disposed on one side of the cured mixture. For example, the film may be a 200 nm silver film. In another embodiment, the film can be affixed to one of the slides or directly to the cured mixture.

In another embodiment, a post-exposure UV curing procedure fully develops the structure and enhances a phase separation between the polymer and the solvent. Upon opening the sandwiched sample, the solvent evaporates and a periodic refractive index modulation is created in the mixture.

In one embodiment, a photosensitive pre-polymer syrup—a mixture of monomer, photoinitiator, co-initiator, liquid crystal, reactive solvents, and non-reactive solvents—is prepared and sandwiched between two glass slides. This embodiment uses a holographic photo-patterning that combines the techniques of holography and laser induced polymerization in which the pre-polymer syrup is exposed to the spatial interference pattern introduced by multiple coherent laser beams. Photo-polymerization will therefore lead to higher polymerization in the high intensity regions of the interference pattern. In another embodiment, a post-exposure UV curing procedure fully develops the structure and enhances a phase separation between the polymer and the solvent. Upon opening the sandwiched sample, the solvent evaporates and a periodic refractive index modulation is created in the mixture.

The invention may also be described as a photonic bandgap structure created by using the methods of this invention. The photonic bandgap structure can be utilized in a multispectral imaging device comprising an image capture device, a processor, an electronic image storage device, and a photonic bandgap filter having a graded, periodic grating.

In one embodiment of a device utilizing the photonic bandgap structure, the processor is in communication with the image capture device and the electronic image storage device is in communication with the processor.

In another embodiment, the photonic bandgap filter is configured to be movable across the image capture device. The image capture device has a field of view in which it captures an image. The processor is configured to store a first image of the field of view captured by the image capture device without the photonic bandgap filter placed in front of the image capture device's field of view and move the photonic bandgap filter across the image capture device's field of view. While the photonic bandgap filter is moving across the image capture device's field of view, the processor may be configured to capture, from the image capturing device, and store a plurality of images at regularly timed intervals. The processor can then combine the first image and the plurality of images to create a multispectral or hyperspectral image.

In another embodiment, a one-step fabrication method to realize a novel graded, periodic holographic photopolymer reflection grating is presented. The period of the reflector at different position along the structure is varied gradually, leading to a rainbow-colored reflection image in the same viewing angle. Compared to previously reported graded photonic or plasmonic structures prepared by expensive focus ion beam (FIB) milling or electron beam lithography techniques, this holographic photo-patterning method is low-cost for large area fabrication. For example, the invention provides graded holographic photopolymer reflection grating filters which can be used in an ultra-compact multispectral imager. The invention can be integrated with portable electronics including cell phones, web-cameras, and laptops. The grating filters, when used in combination with an imaging device can be used for multiple purposes, including diagnostics and anti-counterfeiting with a high degree of accuracy at a low cost.

Other features of the invention can be found in the following description, the enclosed claims and/or the attached drawings.

### BRIEF DESCRIPTION OF THE DRAWINGS

For a fuller understanding of the nature and objects of the invention, reference should be made to the accompanying drawings and the subsequent description. Briefly, the drawings are:

FIG. 1 is the reflection image of a photonic bandgap structure according to one embodiment of the present invention under white light illumination;

FIG. 2A is a diagram showing the step of exposing the pre-polymer mixture to electromagnetic radiation through a prism according to one embodiment of the present invention;

FIG. 2B is a magnified view of the cut out in FIG. 2A showing in greater detail the pre-polymer mixture according to one embodiment of the present invention;

FIG. 3A is a diagram showing the step of exposing the pre-polymer mixture to electromagnetic radiation through a cylindrical lens according to one embodiment of the present invention;

FIG. 3B is a magnified view of the cut out in FIG. 3A showing in greater detail the pre-polymer mixture according to one embodiment of the present invention;

FIG. 4 is two flowcharts showing methods of making a photonic bandgap structure according to two embodiments of the present invention;

FIG. 5 is a chart illustrating the transmission spectrum at different positions of a photonic bandgap structure made according to the present invention;

FIG. 6A is a diagram showing the path of a collimated laser beam as it travels through a cylindrical lens and a pre-polymer mixture according to one embodiment of the present invention;

FIG. 6B is a magnified view of the cut out in FIG. 6A showing in greater detail the pre-polymer mixture according to one embodiment of the present invention;

FIG. 7 is a diagram showing the apparatus used to observe the optical characteristics of a photonic bandgap structure made according to one embodiment of the present invention;

FIGS. 8A, 8B, and 8C are cross-sectional images taken with a scanning electron microscope of a photonic bandgap structure made according to one embodiment of the present invention;

FIG. 9A comprises of reflected images taken at different positions along a photonic bandgap structure made according to one embodiment of the present invention;

FIG. 9B is a schematic illustration made to model the dimensions of the photonic bandgap structure made according to one embodiment of the present invention;

FIG. 9C comprises of scanning electron microscope images of a photonic bandgap structure made according to one embodiment of the present invention, taken at the green and red regions;

FIG. 10A is a microscope image of grooves that were milled at different depths in a photonic bandgap structure made according to one embodiment of the present invention;

FIG. 10B is a graph showing the depth profile of the grooves shown in FIG. 10A as measured by an atomic force microscope;

FIG. 11A is a graph showing the reflection spectrum at different positions along a photonic bandgap structure made according to one embodiment of the present invention;

FIG. 11B is a graph showing the reflection spectrum at different positions along a photonic bandgap structure having a thin reflective film made according to one embodiment of the present invention;

FIG. 12 is a graph showing reflection spectra measured at different positions along a photonic bandgap structure made according to one embodiment of the present invention;

FIG. 13A is a diagram showing the side view of a flexible photonic bandgap structure made according to one embodiment of the present invention on a column;

FIG. 13B is a top down view of the measurement geography of the flexible photonic bandgap structure in FIG. 13A;

FIG. 13C is a graph showing the transmission spectra of normal incidence on the flexible photonic bandgap structure in FIG. 13A;

FIG. 14A shows the measurement geometry and dispersion curves of a flexible photonic bandgap structure made according to one embodiment of the present invention for different displacements;

FIG. 14B shows the measurement geometry and dispersion curves of a flat photonic bandgap structure made according to one embodiment of the present invention for different displacements;

FIG. 15 is a graph showing the reflection spectra in the visible and ultra-violet bands of a photonic bandgap structure made according to one embodiment of the present invention; and Table 1 is a table showing optical property analysis of a photonic bandgap structure made according to one embodiment of the present invention.

### FURTHER DESCRIPTION OF THE INVENTION

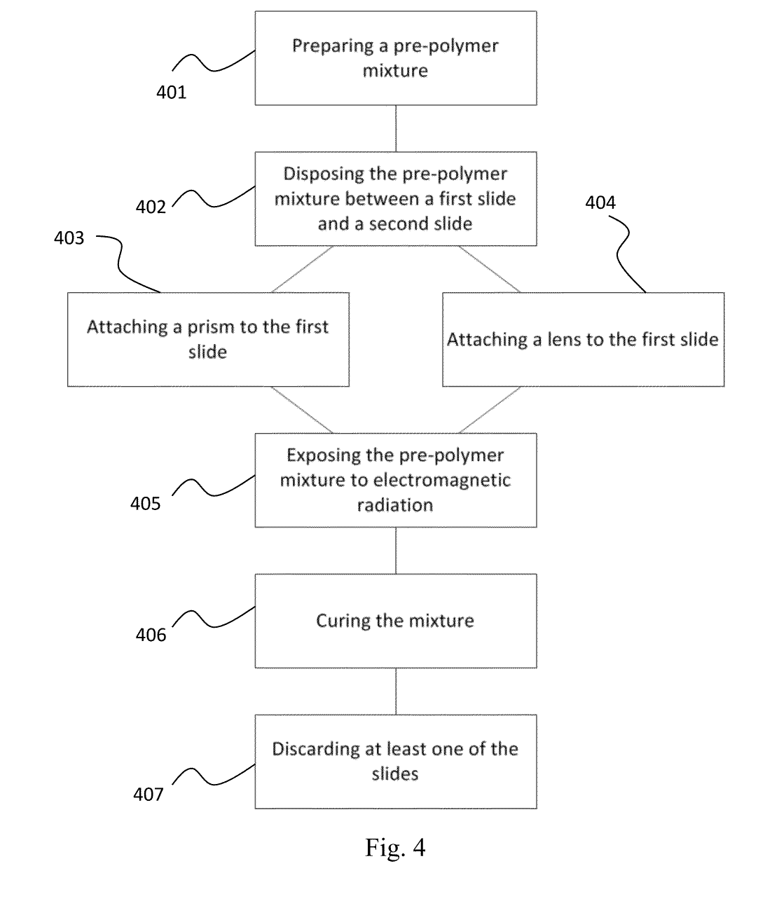

The present invention may be described as a method of making a photonic bandgap structure. FIG. 4 illustrates two such methods. Generally, photonic bandgap structures can be described as optical nanostructures that manipulate the propagation of photons. The photonic bandgap structures herein may contain periodic, regularly repeating internal regions of high and low refractive indices. The areas of high and low refractive indices are created due to polymerization caused by exposure to a spatial interference pattern created by passing a collimated laser beam through a lens or prism. This refractive index modulation changes the transmission/reflection of light in such a way that prevents certain wavelengths of light from propagating through the structure. Photonic bandgap structures are attractive optical materials for controlling and manipulating the flow of light and can be employed in thin film optics ranging from low or high reflection coatings on lenses, mirrors and optical filters to photonic crystal fibers for optical communications.

In order to make the photonic bandgap structures herein, a pre-polymer mixture must be prepared 401. This pre-polymer mixture is colloquially referred to as a “syrup.” The pre-polymer mixture is photosensitive, meaning that the mixture may undergo a chemical reaction (such as polymerization), under certain conditions, when exposed to light.

In one embodiment, the pre-polymer mixture comprises at least one monomer, at least one photoinitiator, at least one co-initiator, at least one liquid crystal, at least one reactive solvent mixture and at least one non-reactive solvent mixture.

A monomer is a molecule that may bind chemically to other molecules to form a polymer. In certain embodiments, one, two, or three different types of monomer(s) can be used to form the photosensitive pre-polymer mixture. For example, a single monomer type can be used to form the photosensitive pre-polymer mixture. The monomers of the present invention can have one, two, three, four, or five reactive functionalities. By reactive functionality, it is meant that the monomer can contain, for example, an alkene, alkyne, or α-β-unsaturated system (e.g., ketone, ester, acid, amide, or nitrile, etc.). Suitable monomers used in the invention can be obtained from commercial sources or synthesized by known methods in the art. Non-limiting examples of monomers that can be used in the present invention include, dipentaerythritol hydroxyl penta acrylate (DPHPA), styrene, substituted and unsubstituted acrylates (e.g., methyl acrylate), ethylene, and multifunctional acrylates. In one embodiment, an acrylate monomer: dipentaerythritol hydroxy penta acrylate (DPHPA), is used in the pre-polymer mixture. Many other monomers, or combinations of monomers can be used.

A photoinitiator is any chemical compound that decomposes into free radicals when exposed to light (via photolysis). Some non-limiting examples of photoinitators include benzoyl peroxide and azobisisobutyronitrile (AIBN), nitrogen dioxide, and peroxides. Other examples may include stains or dyes. In one embodiment, Rose Bengal (RB) (4,5,6,7-tetrachloro-2′,4′,5′,7′-tetraiodofluorescein) is used as a photoinitiator. Many other photoinitiators, or combinations of photoinitiators can be used. The pre-polymer mixture may also contain a co-initiator. In another embodiment, N-phenylglycine can be used as a co-initiator.

The reactive solvent is one in which a reactive functionality exists which can be, for example, alkene, alkyne, or α-β-unsaturated system (e.g., ketone, ester, acid, amide, nitrile, lactam, lactone, etc.). Non-limiting examples of reactive solvents include, N-vinylpyrrolidinone (NVP), styrene, methoxyethene, 1,3-butadiene, and oxirane. The non-reactive solvent can be, for example, toluene, benzene, dichloromethane, hexane, and other alkyl and aryl hydrocarbons. Suitable solvents (both reactive and non-reactive) can be obtained from commercial sources. One having skill in the art would recognize suitable combinations of reactive and non-reactive solvents. In one embodiment, N-vinylpyrrolidinone is used as a reactive solvent and toluene (i.e., methylbenzene or phenylmethane) is used as a non-reactive solvent.

A liquid crystal has properties between those of a conventional liquid and those of a solid crystal. For example, a liquid crystal may flow like a liquid, but its molecules may be oriented in a crystal-like way. There are many different types of liquid crystal phases, which can be distinguished by their different optical properties (such as birefringence). When viewed under a microscope using a polarized light source, different liquid crystal phases will appear to have distinct textures. The contrasting areas in the textures correspond to domains where the liquid crystal molecules are oriented in different directions. Within a domain, however, the molecules are well ordered. Liquid crystals can be divided into thermotropic, lyotropic and metallotropic phases. Thermotropic and lyotropic liquid crystal consist of organic molecules. Thermotropic liquid crystals exhibit a phase transition into the liquid crystal phase as temperature is changed. Lyotropic liquid crystal exhibit phase transitions as a function of both temperature and concentration of the liquid crystal molecules in a solvent (typically water). Metallotropic liquid crystals are composed of both organic and inorganic molecules; their liquid crystal transition depends not only on temperature and concentration, but also on the inorganic-organic composition ratio. For the present invention, a variety of liquid crystals can be used. For example, the liquid crystal can be a chiral nematic liquid crystal. In one embodiment, TL213 is used as the liquid crystal for the pre-polymer mixture. TL213 can be obtained from EMD Chemicals Inc., 480 South Democrat Road, Gibbstown, N.J. 08027. Other suitable liquid crystals used in the invention can be obtained from commercial sources or synthesized by known methods in the art.

In one embodiment, the pre-polymer mixture may have a composition of 0.2 wt % Rose bengal, 1 wt % N-phenylglycine, 16 wt % N-vinylpyrrolidinone, 45 wt % DPHPA, 20 wt % Toluene, 17.8 wt % TL213. The pre-polymer mixture may be mixed to ensure homogeneity. For example, the pre-polymer mixture components may be mixed with a mixer for 60 minutes.

Once the mixture is prepared 401, it is disposed 402 between a first slide and a second slide. The slides can be a variety of shapes. (e.g., rectangular, circular, oval, polygon, etc.). The slides must have at least one smooth, flat surface suitable for contact with the pre-polymer-mixture. The slides should also be rigid as to prevent the deformation of the pre-polymer mixture, which would in turn degrade the optical properties of the photonic bandgap structure. The slides may comprise a transparent or translucent material. In one embodiment, the slides are rectangular glass slides, but the slides can be of various materials. For example, the slides can be plastic slides. The slide material can be made of any transparent material that otherwise does not react with the pre-polymer mixture. The thickness of the slides can vary. Standard thickness slides can be purchased from commercial sources. For example, the thickness of the slides can vary from the mm scale to the cm scale.

The pre-polymer mixture is positioned 402 between these slides. For example, the pre-polymer mixture can be poured or deposited onto a slide or injected between the slides. In one embodiment, spacers are used to ensure that a predetermined amount of pre-polymer mixture is applied. For example, 8 μm spacers can be used to limit the thickness of the positioned pre-polymer mixture. Generally, the optical properties of the finished photonic bandgap structure degrade when the thickness of the structure is less than 5 μm. However, the structure can be made to be much thicker. For example, 50 μm to 100 μm structures could easily be created with no change in the optical properties of the completed photonic bandgap structure.

In one embodiment of the invention, a prism is then attached 403 to either the first or second glass slide. The prism may simply be placed on top of one of the slides. In another embodiment, an index matching oil is used to reduce refraction that may occur in between the prism and the slide. In one embodiment, the prism may be affixed to the slide with a clamping device to ensure that the prism stays in place.

The sample, comprising the pre-polymer mixture is positioned between the glass slides, exposed 405 to electromagnetic radiation having a spatial interference pattern, and the pattern created by passing a collimated laser beams through the prism. The collimated laser beam or beams may be focused in one or two dimensions.

In one embodiment, the electromagnetic radiation is supplied by a laser. For example, the laser may be a 532 nm CW solid state laser with 0.5 W exposure power (Verdi V6, Coherent). In this example, the sample is exposed for 60 seconds.

The spatial interference pattern can be created using holographic lithography. Holographic lithography is a technique for patterning regular arrays of fine features without the use of complex optical systems or photomasks. For example, holographic lithography can be performed by creating an interference pattern between two or more coherent light waves and exposing that interference pattern to a recording layer (e.g. a photoresist). In reflection holographic lithography, the spatial interference patterns are generated by the interference between the incoming beam and its reflection beam from a reflective surface. When utilized in following with the present invention, reflection holographic lithography provides a simple and low-cost way to expose the pre-polymer mixture in the sample to electromagnetic radiation.

The methods of making photonic bandgap structures described herein combine the techniques of holography with laser induced polymerization in which photoresists or monomers are exposed to the spatial interference pattern introduced by coherent laser beams. The photo-polymerization of the pre-polymer syrup will therefore lead to periodic refractive index modulation. Thus, photo-polymerization occurs in selected regions of the spatial interference pattern (areas of high coherence) to make a photonic bandgap structure in the cured mixture. With this single-step approach, fabrication of large area photonic bandgap structures in one, two, three dimensions can be achieved.

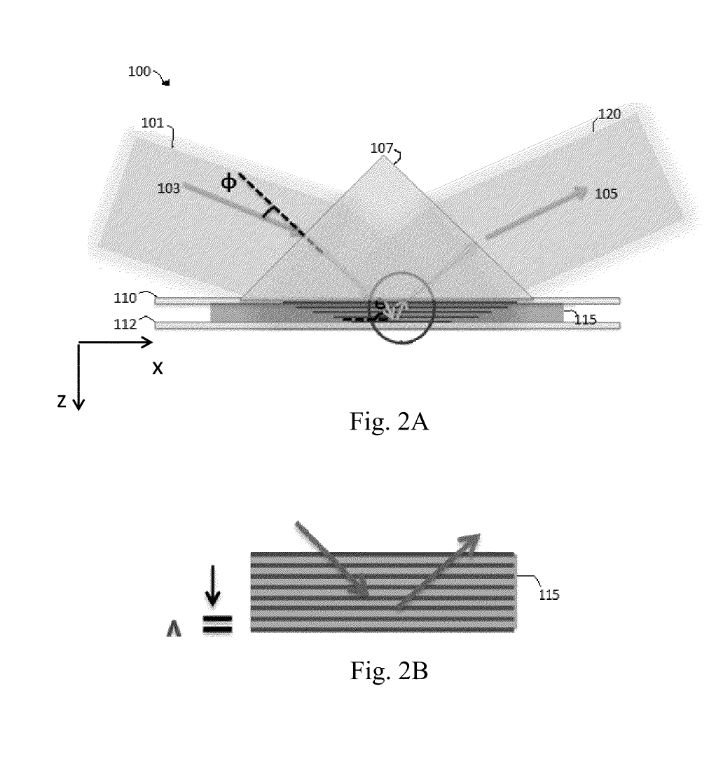

In another embodiment of the invention, the spatial interference patterns can be achieved using a single beam configuration with a triangular prism 107, as illustrated in FIG. 2A. In this geometry 100, the first slide 110 is placed in contact with the hypotenuse of the prism 107 using index matching oil. The optical pattern is formed by the interference between the incoming beam 101 and its own total internally reflected beam at the bottom of the sample (terminating at the second slide 112). Also shown in FIG. 2A and FIG. 2B is the pre-polymer mixture 115 disposed between first slide 110 and second slide 112. Incoming beam direction 103 and outgoing beam direction 105 illustrate the movement of the collimated beam 101.

The interference pattern in the z-direction and its period are determined by the angle of incidence, the refractive index of the glass and pre-polymer mixture, and the recording wavelength, as shown by the following equation.

$$Λ = \frac{{λ}_{Bragg}}{2 {n}_{ave} sin θ} , \\ where θ = {cos}^{- 1} \{ ( \frac{{n}_{prism}}{{n}_{sample}} ) sin [ ( \frac{π}{4} - {sin}^{- 1} ( \frac{1}{{n}_{prism}} sin \frac{φπ}{180} ) ) ] \}$$

In the previous equation, Λ is the photonic bandgap period, nₐᵥₑ is the average refractive index of the recording medium, λ_{Bragg} is the photonic bandgap peak wavelength, and θ and φ are the angles indicated in FIG. 2A.

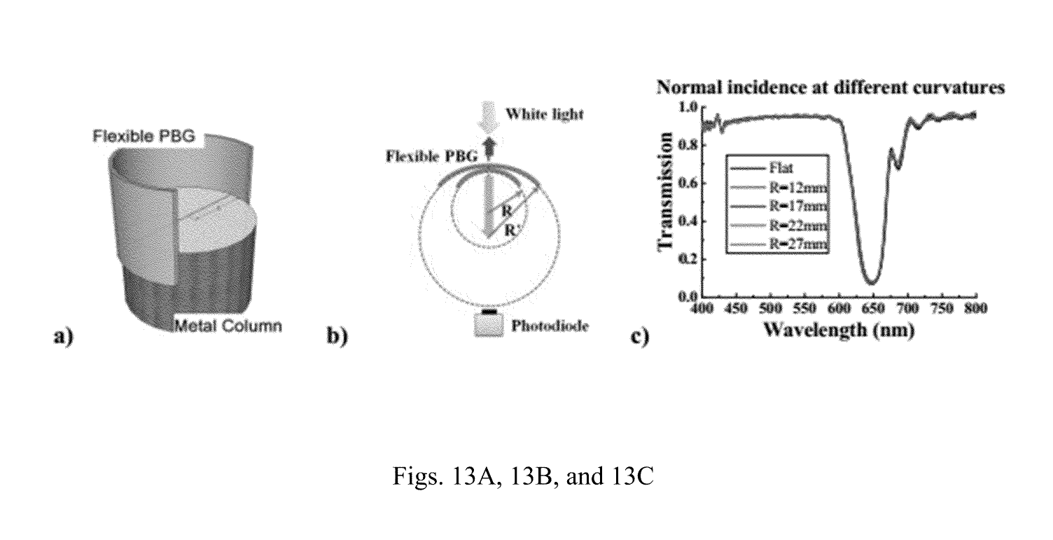

The optical properties of one embodiment of a flexible photonic bandgap structure were characterized. To do this as a function of curvature, the flexible photonic bandgap structure was attached to a series of metal columns with different radii. In order to do the transmission measurements, ˜50% of the film was allowed to extend above the column so that light can transmit through the film to the detector (FIG. 13A). Here, the white light beam (1 mm in diameter) is incident at the center of the curved surfaces (radii of the columns are 12 mm, 17 mm, 22 mm, 27 mm), which is normal to the sample surfaces, and near the top of the metal columns (FIG. 13B). As shown in FIG. 13C the measured transmission spectrum of all samples at normal incidence is nearly identical.

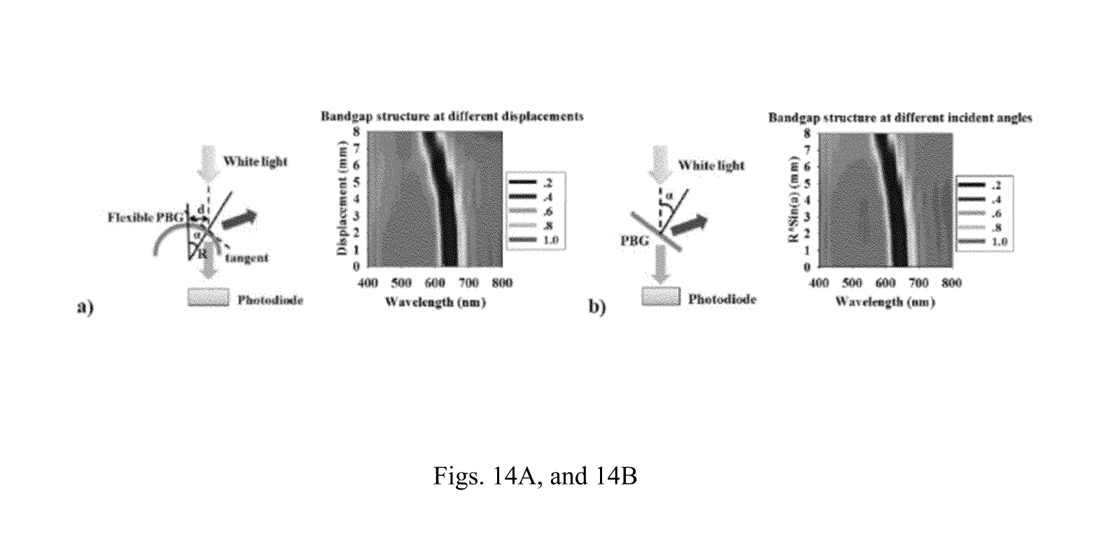

In addition, the optical properties as a function of angle of incidence for curved and flat porous polymer photonic bandgap structures were characterized and compared. Specifically, the samples were illuminated with the white light beam at positions with a displacement of d (d=0 mm, 2 mm, 4 mm, . . . ) from the center of the curved flexible PBG structure attached to the column of radius 12 mm. The resulting transmission spectra, as a function of displacement, are plotted (FIG. 14A). This result can be directly compared to the measurement of the transmission spectra of a flat PBG structure at angles α=sin⁻¹(d/R) (FIG. 14B). The colors in the graph stand for the transmission efficiency. It is obvious that the dispersion curves from these two sets of data are in a good agreement with each other.

One embodiment of the present invention can be described as a fabrication method for a photonic bandgap structure with a continuous, graded period. This embodiment utilizes holographic lithography and one or more optical beams to fabricate the structure.

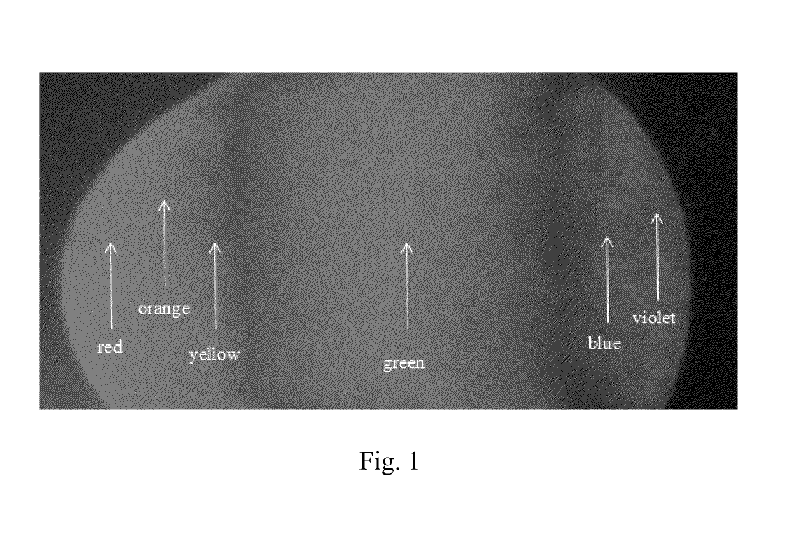

Furthermore, the continuous, graded period of the structure can be formed in a single step, thereby reducing cost. The results of such a method are shown in FIG. 1. As seen in FIG. 1, a rainbow colored photonic bandgap reflector is produced. As discussed above, photoresists or monomers are exposed to a spatial interference pattern introduced by coherent laser beams. In one embodiment, the recording medium (a pre-polymer solution placed in between two glass slides) is placed in contact with the hypotenuse of the prism using optically-matching oil. By optically-matching, it is intended that the oil has the same refractive index as the prism and the glass slide in order to reduce internal reflection of light energy or the refraction of light energy transmitted through the prism to the pre-polymer solution. The recorded interference pattern is formed by the interference between the incoming beam and its own total internal reflected beam at the bottom of the sample.

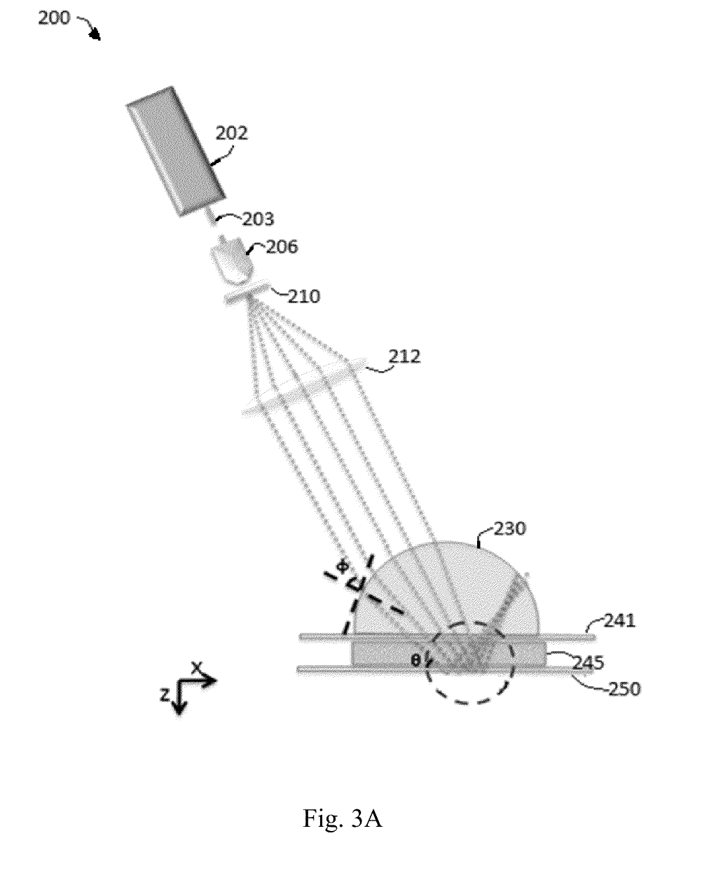

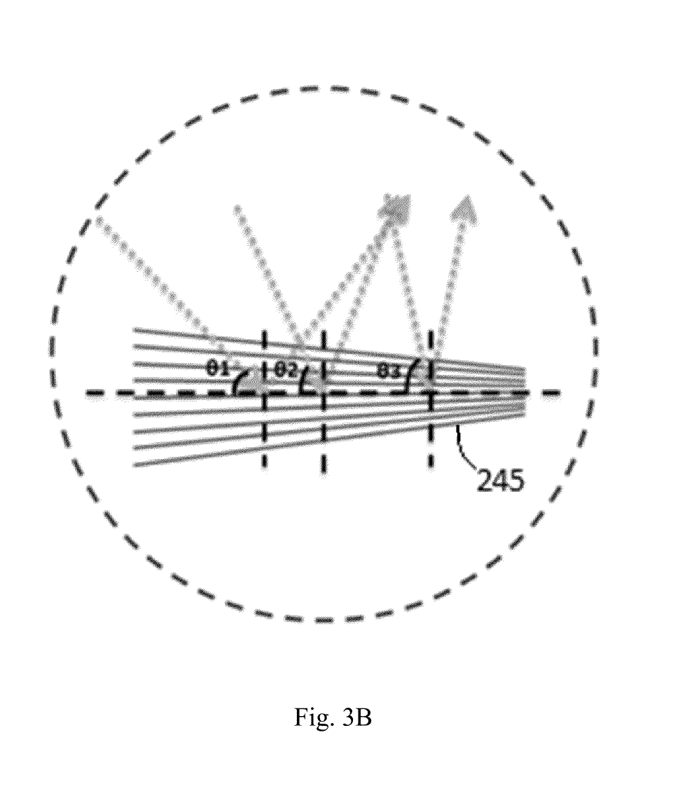

Here, the spatial interference pattern is created by passing a collimated laser beams through a lens. The lens is attached 404 to the first slide. The lens may be a cylindrical, semi-cylindrical, convex-plano, positive meniscus, plano-concave, or biconcave lens. As shown in FIG. 3A, when a collimated laser beam is introduced from a given incident angle, the propagation direction of the refractive light beam will be focused because of the curved surface of the lens 230. As such, the pre-polymer mixture is exposed 405 to electromagnetic radiation. Also shown in FIG. 3A is an equipment setup 200 according to one embodiment of the present invention. A electromagnetic wave generator 202 generates a beam of light 203 which may be focused through aperture 206. The beam passes through a hole 210 in a blocking medium until it is collimated by collimating lens 212. First slide 241, second slide 250, and the pre-polymer mixture 245 is also visible in this figure.

In this case, the incident angle, θ, is slightly different at different positions on the recording media plane. The period of the interference pattern in the z-direction is determined by the incident angle, the refractive index of the recording material and the operational wavelength, as described by the following equation:

$$Λ = \frac{{λ}_{Bragg}}{2 {n}_{ave} sin θ} , where θ = {cos}^{- 1} [ ( \frac{{n}_{prism}}{{n}_{sample }} ) \times cos ( ϕ ) ] .$$

Here, Λ is the period of the photonic bandgap structure, nₐᵥₑ is the average refractive index of the recording film, and λ_{Bragg} is the photonic bandgap peak wavelength, φ is the angle in the glass medium and θ is the angle in the pre-polymer mixture, as indicated in FIG. 3A. The z-axis is chosen perpendicular to the glass slides and the x-axis parallel to the glass slide. Consequently, a continuous variation of incident angles, θ, is achieved by coupling the light through a curved lens surface, which results in a continuously changed period of the spatial interference pattern in the x-direction. (See FIG. 3B).

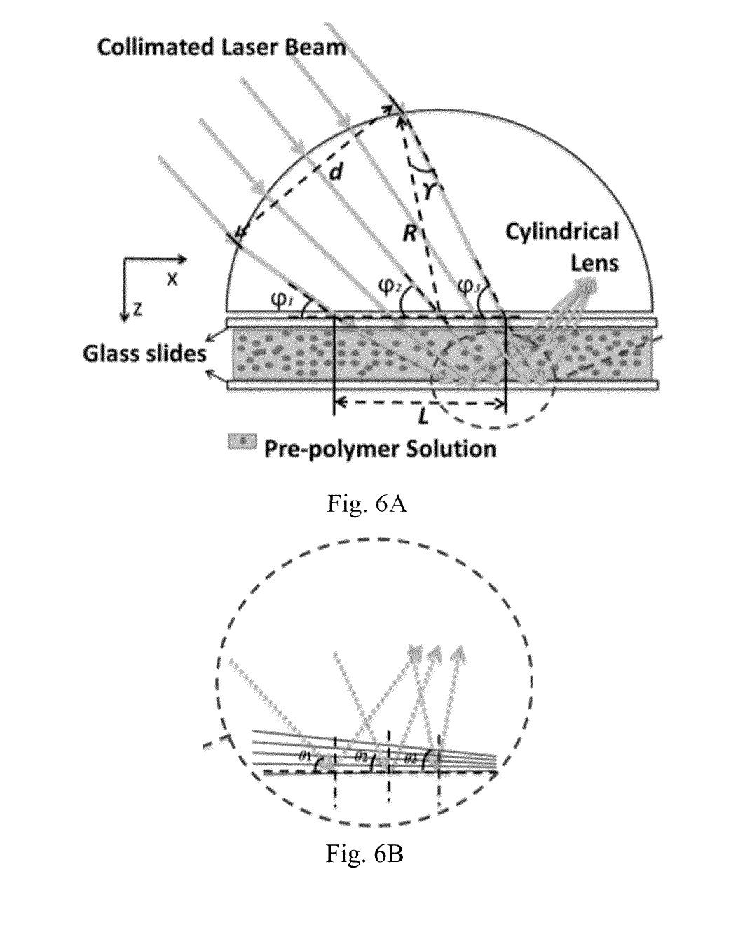

In another embodiment, a cylindrical lens coupling system is used to fabricate graded photonic bandgap reflection grating structures. In a holographic photopatterning system, a cylindrical lens is employed (Thorlab, LJ1728L1-A, focal length: 50.8 mm, Length in x direction: 50.8 mm, Radius: 26 4 mm) to couple the collimated laser beam to illuminate the H-PDLC recording film. A collimated laser beam at 532 nm through an iris, of diameter d, is employed to illuminate the recording film. The incident angle can be estimated by analysis of the optical geometry. In order to obtain a graded grating which reflects the entire visible spectrum (450 nm-650 nm), a central incident ray normal to the lens is selected to produce a reflection grating that reflects light at approximately 550 nm. The corresponding incident angle in glass, φ₂, is chosen to be 55 degrees. Due to the refraction of the cylindrical lens, the rays left of the central ray, as show in FIG. 6A, have incident angles smaller than φ₂ and the rays to the right have incident angles larger than φ₂. Specifically, the angles can be calculated by the following equations:

$$\frac{d}{2 R} \times {n}_{1} = sin ( γ ) \times {n}_{2}$$

$${ϕ}_{1} = {ϕ}_{2} - {sin}^{- 1} ( \frac{d}{2 R} ) + γ , {ϕ}_{3} = {ϕ}_{2} + {sin}^{- 1} ( \frac{d}{2 R} ) - γ$$

As indicated in FIG. 6A, d is the beam diameter set by the iris, R is the radius of the lens, φ₁ is the smallest incident angle and is the largest incident angle in glass. n₁ and n₂ are the refractive indices of air and the lens, respectively. The length, L, of the illuminated sample area in the x direction can also be calculated:

$$L = R \times sin ( γ ) \times [ \frac{1}{sin ( {ϕ}_{1} )} + \frac{1}{sin ( {ϕ}_{3} )} ]$$

Thus, if we have d=30 mm, n₁=1, n₂=1.52, the incident angle will range from 42.6 degrees to 67.4 degrees and the length of the resulting graded reflection grating, L, will be ˜25.6 mm. In this case, the period of the grating is changed continuously from one end of the structure to the other end due to the gradually changed incident angle, corresponding to a reflection peak tuned from blue to red which will be validated in FIG. 11A.

After exposure to electromagnetic radiation, the pre-polymer mixture is cured. As used herein, curing is the hardening or toughening of a polymer by cross-linking. The cured mixture may also be post-cured. As used herein, post-curing is exposing the polymer to elevated temperatures to speed up the curing process. For example the sample may be cured 406 or post-cured under an Hg lamp (100 W, Sylvania) for 24 hours.

The first or second slide is discarded 407. In one embodiment, the first slide is removed allowing the incorporated solvent to evaporate. Because of the methods used herein, the photonic bandgap structure may be flexible.

In one embodiment of the invention, a reflective film is disposed to one side of the cured mixture or on one side of the second slide. For example, the reflective film could be a 200 nm silver film. The reflective film could be any reflective film, especially metallic films with good reflective properties. Some metallic films may reflect certain spectrum bands of light with better results. For example, a gold film may reflect yellow and green better than the blue and red. For example, the amplitude of the interference pattern can be improved significantly by using a metallic film, particularly at the positions where the total internal reflection condition cannot be met (see FIG. 11A). As shown in FIG. 11B, the reflection peak in the blue region (around 480 nm) is significantly improved from ˜50% to ˜80%, confirming the improved interference patterning introduced by a silver 200 nm silver film.

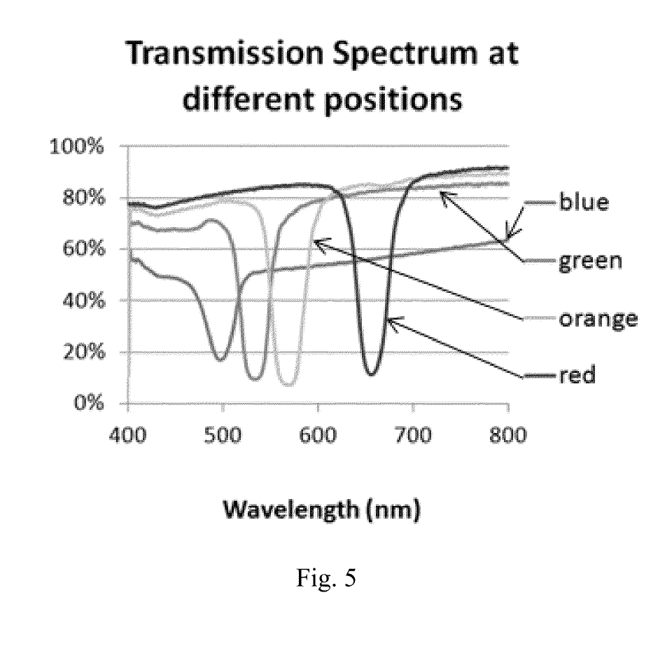

In one example, a lens is used to fabricate a graded, periodic grating structure. Following the method as described above, a graded, periodic grating was fabricated. As shown in FIG. 1, a graded holographic photopolymer reflection grating was fabricated successfully using this system. An obvious rainbow-colored reflection could be observed from the same viewing angle. The length L in the x direction (26±0.5 mm) was approximately the same as the predicted value. To characterize the optical properties of this structure, the normal reflection spectrum was measured at four different positions on this graded grating. As shown in FIG. 1, the reflection peak is continuously tuned from blue to red. FIG. 5 illustrates the transmission spectrum at different positions of this graded grating.

The gradient of the period change in the x-direction can be controlled by using cylindrical lenses with different curved surfaces or by tuning the angle between the recording film and the bottom surface of the lens. For example, a second graded grating was fabricated with the lateral dimension of 8.0±0.5 mm using a shorter focus length cylindrical lens (Melles Griot 01LCP002, focal length: 12.7 mm, Length in x direction: 12.0 mm, Radius: 6.6 mm). The second example shows the ability to create a scalable, high performance graded, periodic rainbow-colored filters of any size and/or bandwidth.

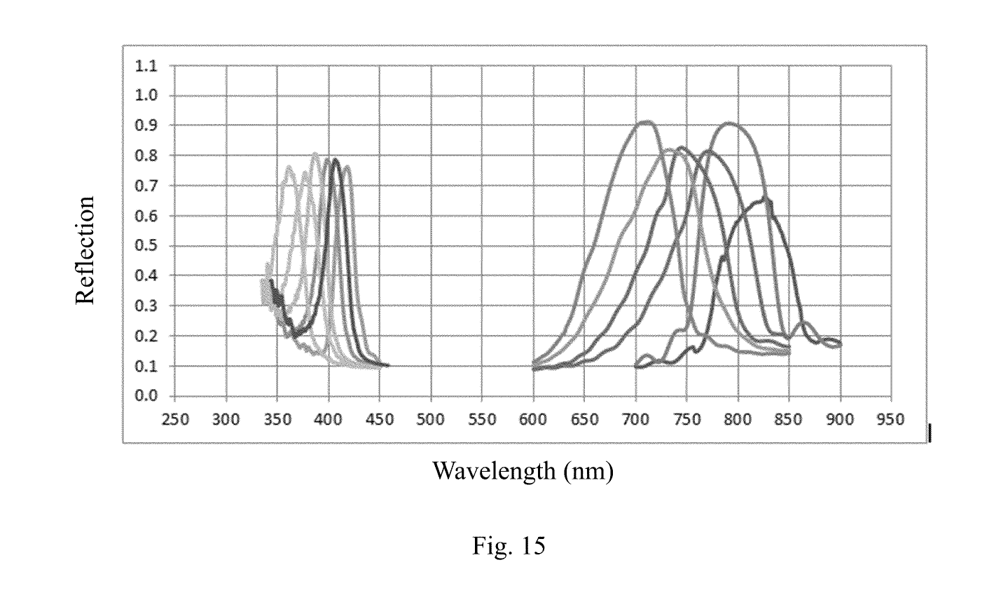

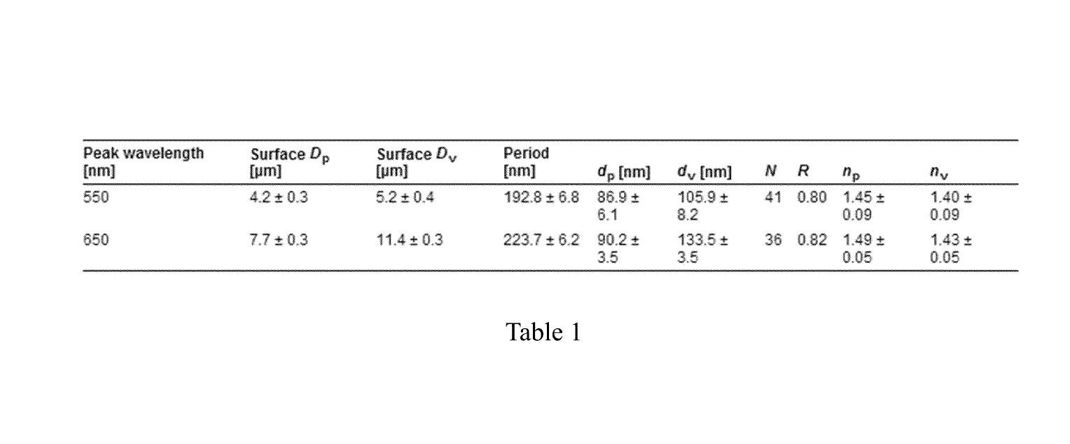

The photonic bandgap structures described herein unexpectedly reflect harmonic wavelengths of light. FIG. 15 illustrates these results. For example, the photonic bandgap structure may reflect light having half the wavelength of the visible spectrum. In this way, a single photonic bandgap structure can be used to reflect (and detect) both the visible and ultra-violet spectra. In another example, the photonic bandgap structure can be tuned (as discussed herein) to detect both infrared and visible spectra. Besides the observed graded rainbow reflection peaks, several different reflection resonances are associated with the periodic layered grating structure with given period due to higher order diffraction. For instance, as the incident angle of the photopatterning is tuned to a larger angle (e.g., 50-60 degrees), the fundamental reflection peak will be tuned to red and IR spectral region (e.g., 600 nm-900 nm). A second order reflection peak in the half wavelength region (i.e. 300 nm-450 nm) is also observable. In this case, when a graded rainbow grating structure is fabricated in the red to IR region, it will have another graded rainbow reflection band in the UV to blue region. This intrinsic feature of layered periodic grating structure is very promising to provide a wider tunability for the proposed multi-spectral imaging applications.

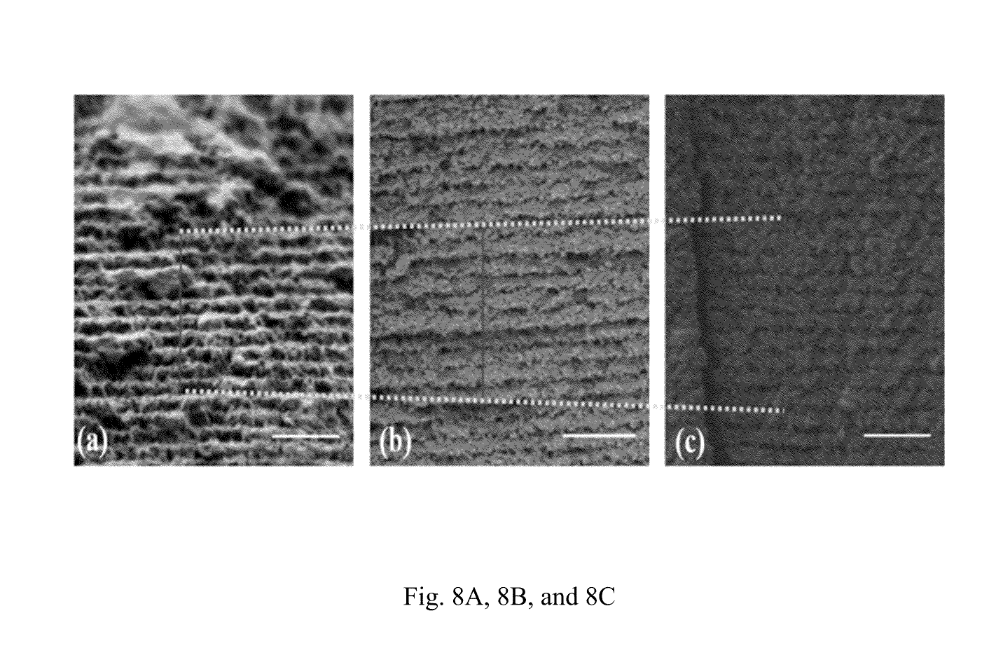

In polymer-based photonic crystal structures, the narrow peak of the optical reflectivity (Δλ/λ<0.1) indicates a constant layer thickness and good layer ordering. This could be confirmed by a low voltage scanning electron microscope (LVSEM) characterization (Zeiss AURIGA Modular CrossBeam workstation), showing that the cross-sectional morphology of the sample consists of multilayers. As shown in FIGS. 8A, 8B, and 8C, LVSEM pictures were taken at three different locations, corresponding to the reflection peaks at ˜485 nm (FIG. 8A), ˜540 nm (FIG. 8B), and ˜650 nm (FIG. 8C). The vertical line in FIGS. 8A, 8B, and 8C shows 10 periods. Fast Fourier Transfer (FFT) data processing was employed to calculate the average period to be approximately 177.6±13.6 nm in FIG. 8A, 192.8±6.8 nm in FIG. 8B and 223.2±6.4 nm in FIG. 8C, respectively. However, due to the intrinsic porous properties of the photopolymer material employed, it is difficult to measure the thickness of the periodic layers accurately from the SEM images. Instead, a high performance transmission electron microscope (TEM) was employed to characterize the detailed structure of the reflection grating. A complicated process is required to cut the structure into ultra-thin slices for TEM characterization, which is extremely demanding in sample preparation. However, due to the random distribution of the nanoporous structures, an individual slice of the grating from a specific position still may not accurately represent the entire structure.

In the following paragraphs, a different, and simpler, non-destructive experimental characterization and theoretical analysis is demonstrated to reveal the detailed structure of the graded grating.

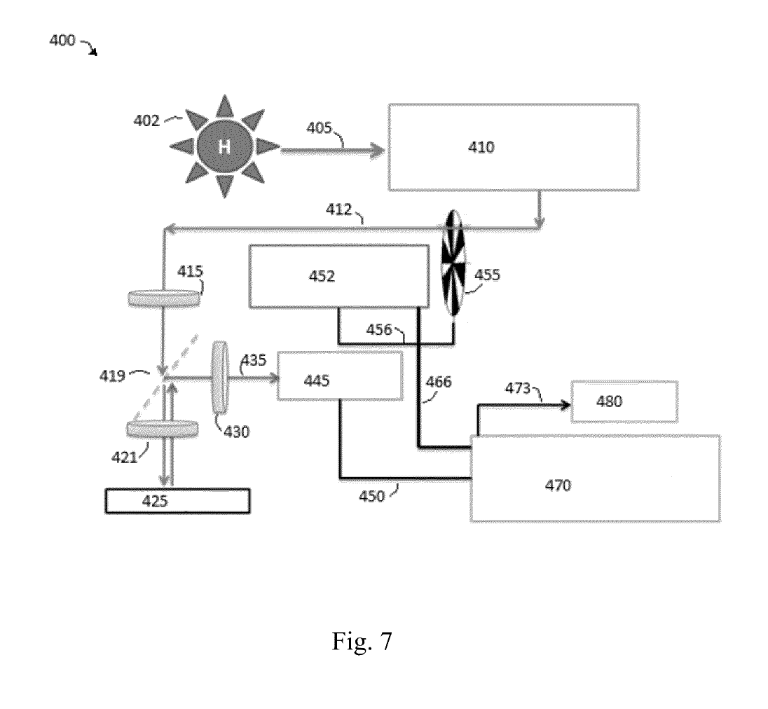

An optical microscope was used to characterize the sample with a white light illumination, a clear surface pattern was observed. More interestingly, this surface grating was also graded. A black-and-white CCD camera was employed (Hamamatsu, C8484-03G) coupled with a 20× objective lens to observe the reflection image. One can see that the period of the surface pattern increases gradually along the grating structure from the blue-reflection region to the red-reflection region. This observation is surprising because it was expected that the interference pattern would only be formed in the vertical direction (i.e. z-direction) rather than in the lateral direction (i.e. x-y plane). In previous experiments, fabrication of the reflection grating using the setup shown in FIG. 7, no surface pattern was observed. The setup 400 in FIG. 7 uses a monochromator 410 to pass incident light 405 from a light source 402 through a light chopper 455. The “chopped” light 412 passes through a lens 415 and angled pass-through mirror 419 and lens 412. The chopped incident light reflects from the sample 425 through lens 412 and is directed by pass-through mirror 419 through a third lens 430. The collected light 435 is detected by a Si Photodetector 445 and converts the collected light 435 to an electrical signal 450. The electrical signal 450 is transmitted to a lock in amplifier 470 with output 473 to a PC 480. The lock in amplifier 470 feeds back an electrical signal 466 to chopper controller 452 which in turn operates the spead of light chopper 455.

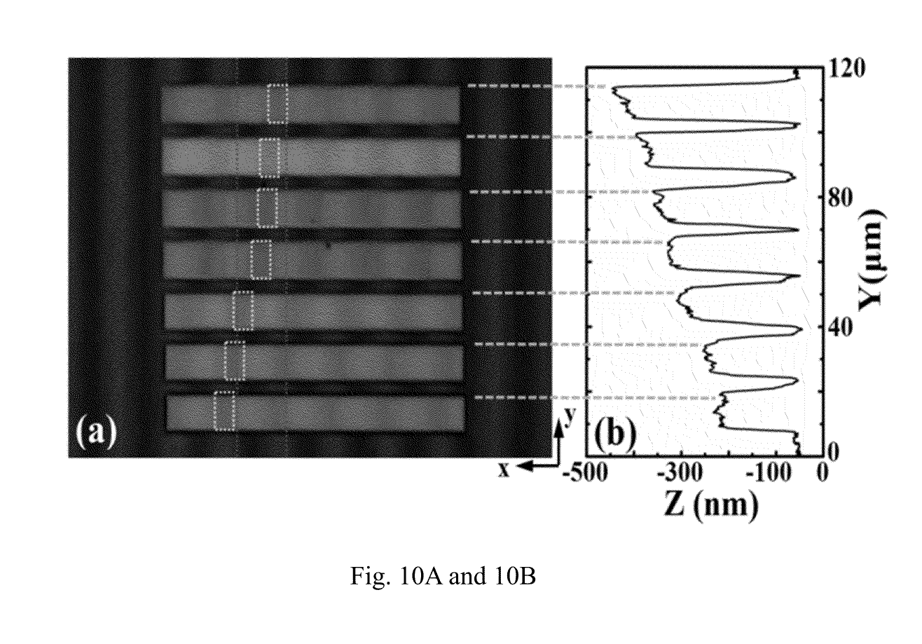

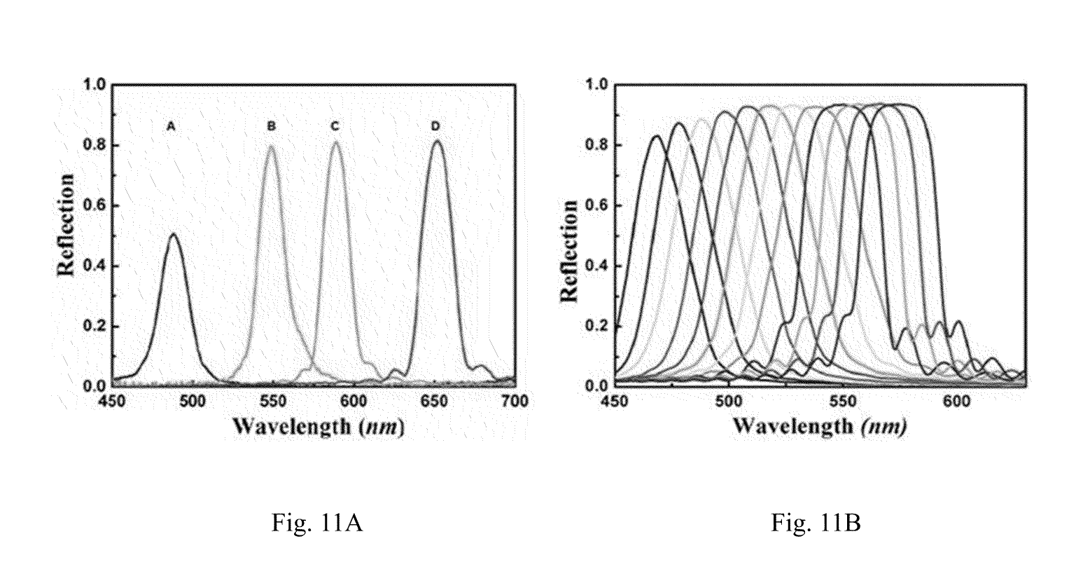

To understand these graded surface patterns, the geometric properties of the graded reflection grating have to be revisited. As discussed previously in FIG. 10, the graded periodic layers should be nonparallel to the surface of the H-PDLC film. These nonparallel interfaces of each layer will terminate at the top surface leading to the graded surface gratings. Although the thickness, t, of each layer is only around 200 nm, the intersection region to the top surface is relatively large due to the tiny angle, φ, between these two planes.

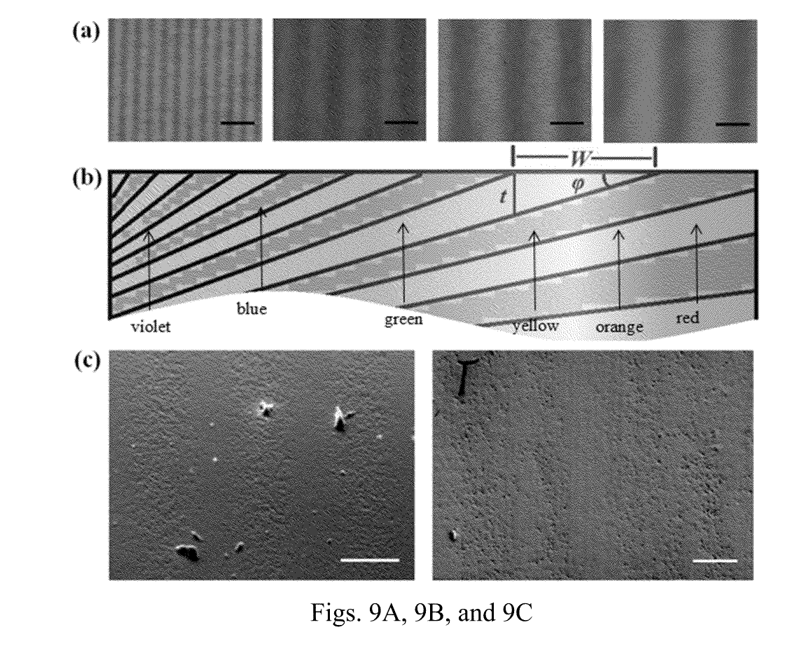

To analyze the details of a surface grating at different regions, SEM images were captured to characterize surface morphologies at two different positions in the green and red regions respectively, as shown in FIG. 9. The period of the surface grating was approximately 9.3 μm in the green region (left) and 19.1 μm in red grating (right). Importantly, one can measure the dimensions of the polymer-rich region and void-rich region, which are 3.7±0.1 μm and 4.8±0.2 μm in the green region (left), and 7.5±0.3 μm and 12.2±0.3 μm in the red region, respectively, indicating that the spatial ratio between the two layers is 0.77:1 in the green region and 0.61:1 in the red region. This characterization is clearly more easily performed and, potentially, as accurate as those results obtained using TEM characterization of randomly picked sample slices from the embodiment shown in FIG. 2A. Interestingly, by measuring the surface grating width, one can further estimate the intersection angle, rp, between the filter layer and the top surface, which is given by tan(φ)=t/W [see FIG. 9]. For example, the intersection angle is approximately 1.19 degrees in the green region [tan(φ)≈192.8 nm/9.3 μm] and 0.67 degrees in the red region [tan(φ)≈223.7 nm/19.1 μm]. This tilted angle can be controlled by the focusing capability of the cylindrical lens employed in the fabrication process.

In order to verify the estimate of the tilted angle introduced by the cylindrical lens, grooves with various depths are milled in the red region using an FIB system (Zeiss AURIGA Modular CrossBeam workstation). As shown in the microscope image in FIG. 10A, each groove is 100 μm×10 μm, separated by 5 μm from each other. The depth of the grooves is controlled by the FIB milling time. One can see that the periodic surface grating is shifted in the grooves at different depths. An atomic force microscope (AFM, VEECO Dimension 3100) was used to measure the depth profile as shown in FIG. 10B. The depth difference between the first and the last groove is ˜220 nm, which approximately represents one period in the z-direction in the red region. One can see that the surface grating pattern [see the dotted squares in FIG. 10A] shifted by one period [see the two dotted lines in FIG. 10A] in the x-direction as the depth increased, which agrees reasonably well with the estimates and reveals the dynamics of the phase separation inside the graded grating.

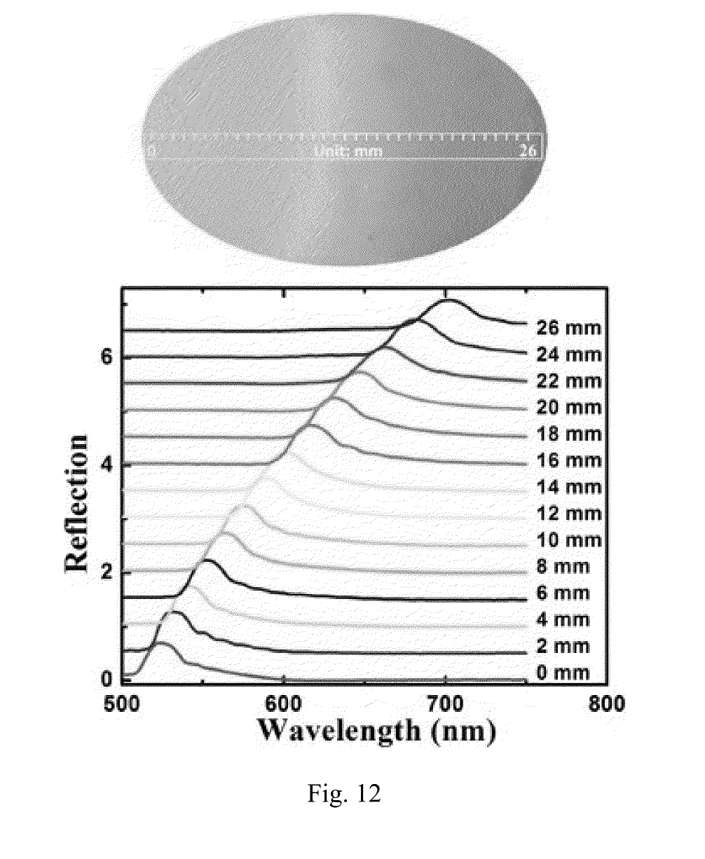

To demonstrate the tunability of the resonant wavelength, another graded grating was fabricated at the angle (φ₂) of ˜49.5° and the reflection peaks were characterized at different positions along the structure. According to the design principle explained previously, this slightly larger incident angle will form larger interference patterns as compared with the sample shown in FIG. 1, leading to red-shifted resonant wavelengths. As shown in FIG. 12, one can see that the resonant wavelength was tuned from approximately 520 nm to 702 nm over the 26 mm distance in the lateral direction. The resonant wavelengths in the red-edge region around 700 nm could find important and new applications for compact/hand-held multispectral imaging of plant health and classification of vegetation.

Based on the geometric information extracted from the SEM morphology of the top surface, the structural properties that resulted in the observed optical properties of the structure can be estimated. For a perfect multilayer photonic bandgap structure, the reflectivity is dependent on the number of layers (N), layer thickness (d) and the refractive index modulation between each layer. The wavelength of the peak reflectivity (λ) can be calculated from λ=2(nₚdₚ+nᵥdᵥ) where nₚ and nᵥ are the refractive index of the polymer-rich layer and the void-rich layer with the thickness of dₚ and dᵥ, respectively. The peak reflectivity (R) of N layers of photonic bandgap structures can be calculated by:

$$R = {[ \frac{1 - {( \frac{\text{?}}{\text{?}} )}^{\text{?}}}{1 + {( \frac{\text{?}}{\text{?}} )}^{\text{?}}} ]}^{\text{?}}$$

$$\text{?} \text{indicates text missing or illegible when filed}$$

where nᵥ<nₚ. As discussed earlier, the periods of the two structures shown in FIG. 9C correspond to the reflection peak at 550 nm [green, FIG. 8b] and 650 nm [red, FIG. 8c], respectively. Substituting the data extracted from the characterization of surface morphology and the optical reflectivities at these two peak wavelengths (see Table 1), the refractive index modulation (Δn) of the nanoporous structure at different positions along the graded grating was estimated based on the equations above.

Table 1 describes the optical property analysis on the multilayered film at different positions along the x-direction of the grating structure. Dₚ is the width of the polymer-rich region and Dᵥ is the width of the void-rich region on the surface, dₚ and dᵥ are the estimated polymer-rich and void-rich layer thicknesses and nₚ and nᵥ are the calculated effective refractive index of each layer, respectively.

As shown in Table 1, the refractive indices, nₚ and nᵥ, both vary along the x-direction of the structure, which was created by the graded optical interference pattern based on a cylindrical lens system shown in FIG. 6A. Importantly, these different periods were fabricated on a single film using a one-step, low-cost, and scalable holographic photopatterning method. Moreover, this graded PBG structure is tuned continuously, which can achieve a higher spectral resolution than is possible from using the limited number of spectral bands defined by a conventional multi-layered optical filter assembly.

Optical Characterization:

The normal reflection spectrum was recorded by illuminating the sample with the chopped collimated output from a halogen lamp propagating through a monochromator (Princeton Instruments, Acton 2750) and a cubic beamsplitter. The reflected light was then collected by a silicon photodetector connected to a lock-in amplifier (Stanford Instruments, SR830) as shown by the schematic setup in FIG. 7.

Thus, a one-step and low-cost method to produce graded rainbow-colored holographic reflection gratings based on porous H-PDLC materials is successfully developed. Due to the curved surface of the lens, the incident angle of the light beam is modulated and leads to a continuously graded period of the interference pattern. The cross-sectional and top surface morphology were both characterized to reveal the graded, periodic and porous structural properties. Interestingly, graded periodic structures at the nanometer-level and micrometer-level were fabricated in the vertical and lateral directions simultaneously. This technique provides a method to fabricate graded optical elements using lenses with curved surfaces, which can be extended to two-dimensional or three-dimensional patterns using advanced optics (e.g. cylindrical, plano-convex, positive meniscus, plano-concave or biconcave lenses). This low cost rainbow-colored filter can be integrated with detectors or imaging devices to realize novel compact and portable spectroscopic analyzers which could be applied to miniaturized and more affordable multispectral or hyperspectral imaging applications. It is clear that these structures provide aesthetically pleasing structures that can be designed to respond to environmental changes beyond what has been previously demonstrated with vapor sensing using reflective gratings. Importantly, these properties are also highly desired in transformation optics and metamaterials, and bio-inspired photonics.

The invention may also be described as a multispectral imaging device. The device may comprise an image capture device, a processor, an electronic storage device, and a photonic bandgap structure as produced above. Here, the photonic bandgap structure is used as a filter.

The image capture device may be a digital camera, such as one found in a mobile phone, laptop, DSLR, point-and-shoot camera, or any other image capture device known in the art. The image capture device has a field of view in which corresponding images are captured.

In one embodiment, the processor may be a general purpose CPU, such as one found in a personal computer. The processor may be a specialized processor designed to quickly process and store images, such as those found in commercial and consumer cameras. The processor is in communication with the image capture device, however, the processor does not need to be located in physical communication with the image capture device. For example, the processor could be located on a device separate from the image capture device and connected electronically (e.g., through a USB or Ethernet cable) or wirelessly (e.g. through Wi-Fi, RF, etc.). The processor is configured to capture images using the image storage device.

The image storage device is also in communication with the processor. In one embodiment, the image storage device is a hard drive or flash drive. The electronic image storage device may be a remote storage device, such as cloud-based storage. The storage device must be able to store electronic images.

In one embodiment, the photonic bandgap filter has a graded, periodic grating. The photonic bandgap filter may be produced using the methods described above. The photonic bandgap filter is configured to be movable across the image capture device's field of view. For example, the filter may be configured to move across the CMOS or CCD sensor in a digital camera. The bandgap filter may be moved continuously or configured to move to predetermined locations.

Regardless of how the bandgap filter moves in relation to the image capture device's field of view, the processor may be configured to store a first image, captured by the image capture device, of the field of view without the photonic bandgap filter. The image is then stored in memory, such as the electronic image storage device. As the photonic bandgap filter is moved across the field of view of the image capture device (as described above), the processor stores a plurality of images. The images may also be stored in memory, such as the electronic image capture storage device.

Using the first picture and the plurality of pictures, the processor may compose a multispectral image by combining the images using algorithms known to those skilled in the art.

As described above, a graded holographic photo-polymer reflection grating can be fabricated easily through optical interference patterning. In one embodiment, the reflection band of the graded structure varies from blue to red at different positions along the grating. In other words, multiple optical filters are assembled in a very compact manner in this graded grating structure (see FIG. 1), which is very suitable to function as the wavelength selection element for the proposed ultra-compact multispectral imager.

In another embodiment, the graded grating is a “color” reflector. If it is placed in front of a miniaturized CCD camera (in cell phones, web-cameras or laptops), one can see that a different color is filtered in the transmission signal, which is slightly different from conventional multispectral imager. In commercial products, a transmission selection color filter is used to select different wavelengths to get into the camera. However, in this embodiment, a different color is filtered out. To address this difference, a reference picture without any optical filter in front. After that, multiple images are taken as the graded grating moves in front of the compact camera. In this case, the difference between the reference picture and the signal picture is the spectral image at each narrow reflection band. With known data processing techniques, the multispectral imaging can be realized. This product design can be easily integrated with portable electronic devices like cell phones and laptops.

In another embodiment, a photonic bandgap structure having a graded, periodic grating can be used with an imaging device in various important applications for civil life, for example, to monitor the health of plants, safety of food, drink and medicine, anti-counterfeiting of jade, colorful cosmetics and luxury products, etc.

This disclosure provides a low-cost and single-step method to fabricate large area graded PBG structure to used in the current invention. Compared to other techniques such as multi-layer deposition, the invention is a more cost-effective and faster way to get a large batch of the products. Moreover, our graded photonic bandgap structure can be tuned continuously, which can achieve higher resolution compared to the limited numbers of spectral bands defined by an optical filter assembly. The size of the rainbow pattern can be controlled by the size and angle of the prism or lens employed in the fabrication setup and therefore is highly customized. In addition, this graded photonic bandgap structure can be manufactured small and thin, and intergrated into commercial spectrascopic products easily. In another embodiment, a or convex-plano lens can be used to focus the beam in two dimensions. A continuous variation of incident angles is achieved by coupling the light through the curved lens surface, which results in a continuously changed period of the spatial interference pattern. This continuously changed period is illustrated in the magnified portion of FIG. 3B.

Some graded photonic bandgap structures of the present invention could be integrated into miniaturized spectral scanners, compact and portable multispectral imagers or analyzers, holographic scanners, bar code scanners, and laser printers. Some embodiments can also function as a novel currency anti-counterfeiting technology. For example, if the photonic bandgap structure is used as a filter, the specific wavelength or wavelengths of light reflected from a genuine article can be detected using a filtered imaging device. Another embodiment of the invention can be used as a continuously graded band-stop filter.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method of making a photonic bandgap structure, the method comprising the steps of:
preparing a photosensitive pre-polymer mixture comprising at least one monomer, at least one photoinitiator, at least one co-initiator, at least one liquid crystal, at least one reactive solvent, and at least one non-reactive solvent;
disposing the pre-polymer mixture between a first slide and a second slide;
attaching a prism to the first slide;
exposing the pre-polymer mixture to electromagnetic radiation having a spatial interference pattern, the pattern created by passing one or more collimated laser beams through the prism;
curing the mixture; and
discarding at least one of the first or second slides,
wherein photo-polymerization occurs in selected regions of the spatial interference pattern to make a photonic bandgap structure in the cured mixture.

2. The method of claim 1, wherein the monomer is dipentaerythritol hydroxy penta acrylate, the photoinitiator is Rose Bengal, the coinitiator is N-phenylglycine, the reactive solvent is N-vinylpyrrolidinone, the liquid crystal is TL213, and the non-reactive solvent is toluene.

3. The method of claim 1, wherein a reflective film is disposed on one side of the second slide.

4. The method of claim 3, wherein the reflective film comprises a 200 nm silver film.

5. The method of claim 1, wherein the photonic bandgap structure is flexible.

6. A photonic bandgap structure made by the method of claim 1.

7. A method of making a photonic bandgap structure having a graded, periodic grating, the method comprising the steps of:
preparing a photosensitive pre-polymer mixture comprising at least one monomer, at least one photoinitiator, at least one co-initiator, at least one liquid crystal, at least one reactive solvent, and at least one non-reactive solvent;
positioning the pre-polymer mixture between a first slide and a second slide;
attaching a lens to the first slide;
exposing the pre-polymer mixture to electromagnetic radiation having a spatial interference pattern, the pattern created by passing one or more collimated laser beams through the lens;
curing the mixture; and
discarding at least one of the first or second slides,
wherein photo-polymerization occurs in selected regions of the spatial interference pattern to make a graded, period grating in the cured mixture.

8. The method of claim 7, wherein the lens is a cylindrical lens.

9. The method of claim 7, wherein the lens is a convex-plano lens.

10. The method of claim 7, wherein the collimated laser beam is focused in one dimension.

11. The method of claim 7, wherein the collimated laser beam is focused in two dimensions.

12. The method of claim 7, wherein the monomer is dipentaerythritol hydroxy penta acrylate, the photoinitiator is Rose Bengal, the coinitiator is N-Phenylglycine, the reactive solvent is N-vinylpyrrolidinone, the liquid crystal is TL213, and the non-reactive solvent is toluene.

13. The method of claim 7, wherein the slides are glass.

14. The method of claim 7, wherein the lens is attached to one of the slides using a refractive index matching material.

15. A photonic bandgap structure having a graded, periodic grating made by the method of claim 7.

16. A multispectral imaging device comprising:
an image capture device having a field of view;
a processor in communication with the image capture device;
an electronic image storage device in communication with the processor;
a photonic bandgap filter having a graded, periodic grating, the photonic bandgap filter configured to be movable across the field of view of the image capture device,
wherein the processor is configured to:
store a first image captured by the image capture device without the photonic bandgap filter in the field of view;
store, while the photonic bandgap filter is moving across the field of view of the image capture device, a plurality of images at regularly timed intervals; and
combine the first image and the plurality of images to make a multispectral image.

17. The device of claim 16, wherein the photonic bandgap filter is made by the method of claim 7.
